(19) United States
(12) Patent Application Publication
(10) Pub. No.: US 2019/0322852 A1
(43) Pub. Date: Oct. 24, 2019

(54) RUBBER COMPOSITION FOR DYNAMIC DAMPER AND DYNAMIC DAMPER COMPRISING THE SAME

(71) Applicants: Hyundai Motor Company, Seoul (KR); Kia Motors Corporation, Seoul (KR); Kunhwa EnG CO., LTD., Gyeongsan (KR)

(72) Inventors: Min Jae Yoon, Suwon (KR); Sun Cheol Jang, Gyeongsan (KR); Jae Young Lee, Gyeongsan (KR)

(21) Appl. No.: 16/119,118

(22) Filed: Aug. 31, 2018

(30) Foreign Application Priority Data
Apr. 24, 2018 (KR) 10-2018-0047215

(51) Int. Cl. C08L 23/16

(52) U.S. Cl. CPC C08L 23/16; C08L 2205/06; C08L 2312/00; C08L 2205/03

(57) ABSTRACT

Disclosed are a rubber composition for a dynamic damper and a dynamic damper including the same. The rubber composition may include a resin including ethylene-propylene-based rubber and halogenated isobutylene-isoprene rubber, a filler, a plasticizer, a crosslinking agent and a vulcanizing accelerator. For example, the rubber composition may be prepared by mixing the resin including the ethylene-propylene-based rubber and the halogenated isobutylene-isoprene rubber, the filler, the plasticizer, the crosslinking agent and the vulcanizing accelerator at an optimal mixing ratio, thus increasing the loss factor thereof while decreasing the temperature dependency thereof across the broad range of temperatures to thereby improve anti-vibration characteristics regardless of changes in season or temperature.

### CROSS-REFERENCE TO RELATED APPLICATION

This application claims, under 35 U.S.C. § 119(a), the benefit of priority to Korean Patent Application No. 10-2018-0047215, filed Apr. 24, 2018, the entire contents of which is incorporated herein for all purposes by reference.

### TECHNICAL FIELD

The present invention relates to a rubber composition for a dynamic damper, which exhibits less temperature dependency on a broad range of temperatures. The rubber composition may also provide improvement in loss factor to thus manifest superior anti-vibration characteristics, and to a dynamic damper comprising the same.

### BACKGROUND OF THE INVENTION

A dynamic damper is a vehicle part that is capable of effectively absorbing vibration at low cost. For example, when the engine frequency and the half-shaft frequency are resonant upon transfer of a driving force, vibration is absorbed by a dynamic damper that is provided to a half shaft, thereby improving performance reducing noise, vibration, and harshness (NVH). For example, the dynamic damper is provided at a vibration-generating portion and is designed to have the same natural frequency as the vibration so as to absorb the generated vibration. Here, the higher the loss factor of the material, the greater the vibration absorption efficiency.

A material for a dynamic damper typically includes a rubber material having superior vibration insulation performance. However, the rubber material becomes hard at low temperatures, whereby the natural frequency thereof increases, and becomes soft at high temperatures, thus decreasing the natural frequency.

In order to increase the loss factor of a dynamic damper in the related art, a material such as butyl rubber has conventionally been used. Although butyl rubber is increased in loss factor, the extent to which the natural frequency is increased is excessively high in the low temperature range (−20° C.), such that the vibration insulation performance as the damper undesirably deteriorates.

Thus, the problems of vibration and noise of vehicles may be caused by substantial temperature dependency and inferior loss factor, which may negatively affect the ride comport of vehicles. Hence, upon application of the dynamic damper, it is necessary to develop rubber that can provide low temperature dependency and maintain a loss factor at a predetermined level or greater, regardless of the environmental factors such as temperature.

### SUMMARY OF THE INVENTION

In preferred aspects, the present invention may provide a rubber composition for a dynamic damper. The rubber composition may include a ethylene-propylene-based rubber and a halogenated isobutylene-isoprene rubber as raw rubber components in order to decrease the temperature dependency and improve the loss factor thereof.

Further provided is a dynamic damper, which may be superior in anti-vibration characteristics regardless of changes in season or temperature due to the reduced degradation sensitivity thereof.

The aspects of the present invention are not limited to the foregoing, and will be able to be clearly understood through the following description and to be realized by the means described in the claims and combinations thereof.

In one aspect, the present invention may provide a rubber composition for a dynamic damper. The rubber composition may include: a resin including an amount of about 70 to 90 wt % of an ethylene-propylene-based rubber and an amount of about 10 to 30 wt % of a halogenated isobutylene-isoprene rubber, based on the total weight of the resin; a filler; a plasticizer; a crosslinking agent; and a vulcanizing accelerator.

The term “resin” as used herein refers to a synthetic or natural polymeric substance, for example, a substance from plant secretions (e.g., raw rubber), or a substance made from organic synthesis using organic solvents (such as ether) and monomeric units (e.g., ethylene or propylene units, and halogenated isobutylene-isoprene units) constituting the repeating structure of the resin polymer. In certain embodiments, the resin may include a raw rubber that may be naturally obtained, or modified rubber that is processed by chemical reactions.

The term “ethylene-propylene-based rubber” as used herein refers to a monomeric unit of a resin composition, which includes ethylene and propylene as a main backbone structure. In addition, the term “halogenated isobutylene-isoprene rubber” as used herein refers to a monomeric unit of a resin composition, which includes halogenated isoprene, for example, isoprene substituted one or more of halogen such as F, Cl, Br, or I, and isopropylene as a main backbone structure.

The term “filler” as used herein refers to a material that is typically incorporated into a resin (e.g., raw rubber) in order to modify the properties of the resin. In preferred aspect, the filler may not react or chemically react with other components in the resin.

The term “plasticizer” as used herein refers to a material or additive that may increase the plasticity or decrease the viscosity of the resin.

The term “crosslinking agent” as used herein refers to a material or additive that initiates, extends, and/or forms polymeric crosslinking between monomers or repeating units of the resin components.

The term “vulcanizing accelerator” as used herein refers to a material or additive that initiates promotes a chemical process for converting the formed resin or polymeric chains, for example, each of polymeric chain may be formed by crosslinking polymeric units, into more durable or rigid form of the resin by introducing crosslinks between such polymeric chains. Preferred vulcanizing may suitably include metal oxides such as zinc oxide, and/or a saturated or unsaturated fatty acid such as stearic acid.

The ethylene-propylene-based rubber may suitably include ethylene propylene diene monomer rubber.

The halogenated isobutylene-isoprene rubber may suitably include chloro-isobutylene-isoprene rubber, bromo-isobutylene-isoprene rubber, or a mixture thereof.

The filler may suitably include at least one selected from the group consisting of carbon black, calcium carbonate, talc, clay, silica, mica, titanium dioxide, graphite, wollastonite, and nano silver.

The plasticizer may suitably include paraffin oil.

The crosslinking agent may suitably include peroxide, sulfur, or a mixture thereof.

The vulcanizing accelerator may suitably include zinc oxide, stearic acid, or a mixture thereof.

The rubber composition may suitably include an amount of about 30 to 40 parts by weight of the filler, an amount of about 15 to 25 parts by weight of the plasticizer, an amount of about 1 to 5 parts by weight of the crosslinking agent, and an amount of about 1 to 5 parts by weight of the vulcanizing accelerator, based on 100 parts by weight of the resin.

The rubber composition may have a natural frequency change of about 70% or less at a temperature ranging from about −20 to about 0° C.

The rubber composition may have a loss factor (tans) of about 0.192 to 0.662 at a vibration frequency of about 50 to 200 Hz and a temperature of about −20 to 100° C.

In another aspect, further provided is a dynamic damper including the above rubber composition as described herein.

Also provided is a vehicle including the dynamic damper as described herein.

Preferably, the rubber composition for a dynamic damper according to the present invention may be prepared by mixing a resin or a raw rubber comprising an ethylene-propylene-based rubber and a halogenated isobutylene-isoprene rubber with a filler, a plasticizer, a crosslinking agent and a vulcanizing accelerator at an predetermined mixing ratio, such that temperature dependency thereof may be reduced across broad temperature range and the loss factor thereof may also be increased, thus exhibiting superior anti-vibration characteristics.

When the rubber composition according to various exemplary embodiments of the present invention is applied to a dynamic damper for a vehicle, ride comfort can be improved regardless of changes in season or temperature due to the low degradation sensitivity thereof.

The effects of the present invention are not limited to the foregoing, and should be understood to include all effects that can be reasonably expected based on the following description.

### BRIEF DESCRIPTION OF DRAWINGS

FIG. 1 is a graph showing an acceleration peak depending on frequency in order to measure a natural frequency according to an exemplary embodiment of the present invention; and

FIG. 2 is a graph showing a dB peak depending on frequency in order to measure a loss factor according to an exemplary embodiment of the present invention.

### DETAILED DESCRIPTION

The above and other aspects, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc. when used in this specification specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. In contrast, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values among others, and thus should be understood to be modified by the term “about” in all cases. Furthermore, when a numerical range is disclosed in this specification, such a range is continuous, and includes all values from the minimum value of said range to the maximum value thereof, unless otherwise indicated. Moreover, when such a range pertains to integer values, all integers including the minimum value to the maximum value are included unless otherwise indicated.

For example, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include any subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

As used herein, the term “frequency change” may refer to a natural frequency change. Also, the term “temperature dependency” refers to the natural frequency value measured in a test temperature range, for example, low temperature range of about −20 to about 0° C. and a high temperature range of about 23 to 100° C., to which the product is subjected. Briefly, it means a change in the natural frequency value relative to the initial natural frequency of the product.

Furthermore, as used herein, the term “loss factor” refers to a dimensionless value determined based on the 3 dB calculation method. Specifically, it is the ratio of the point value at which the resonance point of the product alone is measured and the bandwidth is maintained constant, and the value obtained by calculating the change of the measured frequencies, and is represented as tan δ. The loss factor is an indicator of how much vibration energy can be absorbed when the molded product of the present invention is deformed. The greater the value of tan δ, the wider the region absorbing the vibration energy, such that superior anti-vibration characteristics are ultimately exhibited.

The present invention addresses a rubber composition for a dynamic damper, which includes a resin including a ethylene-propylene-based rubber and a halogenated isobutylene-isoprene rubber. As such temperature dependency of the rubber composition may be reduced across a broad range of temperatures and the loss factor may be increased.

In addition, when the rubber composition according to various exemplary embodiments of the present invention is applied to a dynamic damper for a vehicle, ride comfort may be improved regardless of changes in season or temperature due to the low degradation sensitivity thereof.

In one aspect, the rubber composition for a dynamic damper may include a resin including an amount of about 70 to 90 wt % of the ethylene-propylene-based rubber and an amount of about 10 to 30 wt % of the halogenated isobutylene-isoprene rubber based on the total weight of the resin, a filler, a plasticizer, a crosslinking agent, and a vulcanizing accelerator.

Preferably, the rubber composition for a dynamic damper may suitably an amount of about 30 to 40 parts by weight of the filler, an amount of about 15 to 25 parts by weight of the plasticizer, an amount of about 1 to 5 parts by weight of the crosslinking agent, and an amount of about 1 to 5 parts by weight of the vulcanizing accelerator, based on 100 parts by weight of the resin.

In the resin, which may include a raw rubber, the ethylene-propylene-based rubber may be an ethylene propylene diene monomer(EPDM) rubber. The ethylene-propylene-based rubber functions to improve low-temperature flexibility and to decrease crystallinity, thus effectively enhancing processability and low-temperature properties. Preferably, the ethylene-propylene-based rubber may include EPDM rubber. The EPDM rubber may suitably include an amount of about 45 to 80 wt % of ethylene, an amount of about 20 to 55 wt % of propylene, and an amount of about 1 to 13 wt % of diene based on the total weight of the EPDM rubber.

The ethylene-propylene-based rubber may suitably be used in an amount of 70 to 90 wt % based on the amount of the resin. When the amount thereof is less than about 70 wt %, the frequency change depending on the temperature, which is the main aspect of performance of the dynamic damper, may greatly vary. Here, the frequency change may indicate the natural frequency change. On the other hand, when the amount thereof is greater than about 90 wt %, the loss factor may be remarkably decreased, making it difficult to realize the function as the damper.

In the resin, the halogenated isobutylene-isoprene rubber may suitably include a chloro-isobutylene-isoprene rubber, a bromo-isobutylene-isoprene rubber or a mixture thereof. The halogenated isobutylene-isoprene rubber as used herein may maintain a high loss factor, thus exhibiting superior anti-vibration characteristics.

The halogenated isobutylene-isoprene rubber may be used in an amount of about 10 to 30 wt % based on the amount of the resin. When the amount thereof is less than about 10 wt %, loss factor may deteriorate. On the other hand, when the amount thereof is greater than about 30 wt %, the frequency change depending on the temperature may increase.

The filler as used herein may improve the mechanical properties of the rubber composition. The filler may suitably include at least one selected from the group consisting of carbon black, calcium carbonate, talc, clay, silica, mica, titanium dioxide, graphite, wollastonite, and nanosilver, but is not limited thereto.

The filler may be used in an amount of about 30 to 40 parts by weight based on 100 parts by weight of the resin. When the amount thereof is less than about 30 parts by weight, the mechanical properties thereof may deteriorate satisfy required performance may not be obtained. On the other hand, when the amount thereof is greater than about 40 parts by weight, the mechanical properties thereof may deteriorate due to dispersion problems.

The plasticizer may suitably include paraffm oil, and may be used in an amount of 15 to 25 parts by weight based on 100 parts by weight of the resin. When the amount thereof is less than about 15 parts by weight, processability may decrease, resulting in low productivity. On the other hand, when the amount thereof is greater than about 25 parts by weight, mechanical properties may deteriorate.

The crosslinking agent may suitably include peroxide, sulfur or a mixture thereof. The crosslinking agent may be used in an amount of about 1 to 5 parts by weight based on 100 parts by weight of the raw rubber. When the amount thereof is less than about 1 part by weight, rubber durability may decrease. On the other hand, when the amount thereof is greater than about 5 parts by weight, unsatisfactory heat resistance may result.

The vulcanizing accelerator may suitably include zinc oxide (ZnO), stearic acid or a mixture thereof.

The rubber composition for a dynamic damper may have a natural frequency change of about 70% or less at a low temperature ranging from about −20 to 0° C. When the rubber composition is applied to a dynamic damper, rubber may not be sufficiently hard even at a low temperature ranging from about −20 to about 0° C., and thus the natural frequency may not be increased to about 70% or greater, thereby decreasing the temperature dependency. Preferably, the natural frequency change at a low temperature ranging from about −20 to about −10° C. may be of about 49 to 66%.

Also, the rubber composition for a dynamic damper may have a loss factor (tan δ) of about 0.192 to 0.662 at a vibration frequency of 50 to 200 Hz and a temperature ranging from about −20 to about 100° C. Likewise, when the rubber composition is applied to a dynamic damper, the loss factor (tan δ) required of the damper may be at least about 0.13. The rubber composition according to an exemplary embodiment of the present invention may have a loss factor satisfying the required properties noted above to thus improve anti-vibration characteristics.

In addition, the present invention addresses a dynamic damper comprising the above rubber composition.

In various exemplary embodiments of the present invention, the rubber composition may be prepared by mixing the resin including the ethylene-propylene-based rubber and the halogenated isobutylene-isoprene rubber with the filler, the plasticizer, the crosslinking agent and the vulcanizing accelerator at a predetermined mixing ratio, thus increasing the loss factor thereof while decreasing the temperature dependency thereof at low and high temperatures, ultimately improving anti-vibration characteristics regardless of changes in the temperature.

Moreover, the rubber composition according to preferred exemplary embodiments of the present invention may be applied to any type of damper, such as a cross-member damper for a vehicle requiring damping performance, because of the superior damping performance and low temperature dependency thereof.

### EXAMPLE

A better understanding of the present invention will be given through the following examples, which are merely set forth to illustrate, but are not to be construed as limiting the present invention.

### Examples 1 to 3 and Comparative Examples 1 to 4

The rubber compositions for a dynamic damper were prepared using components in the amounts shown in Table 1 below.

### Test Example 1

### Measurement of Temperature Dependency and Loss Factor Depending on the Component Content of Resin

A dynamic damper was manufactured through the following typical method using the rubber composition of each of Examples 1 to 3 and Comparative Examples 1 to 4.

Method of Manufacturing Damper

(1) Mold Preparation

A mold suitable for an insert mass was prepared, and a core part, a lower mold part and a middle separation plate were coupled with each other. Thereafter, an insert mass was placed in the mold and then the mold was closed with an upper mold part in order to perform an injection process.

(2) Injection Molding

In order to inject the rubber composition of each of Examples 1 to 3 and Comparative Examples 1 to 4, downward hydraulic pressure was applied to the injection part, and thus the rubber composition was injected, and was then maintained at a high temperature for a predetermined period of time.

(3) Completion

The upper mold part and the injection part were raised and then the middle separation plate was removed from the core part and the lower mold part, thereby demolding a damper. Next, buns were removed from the damper using a cutting tool, thereby completing the damper.

Test Method

(1) Measurement of Natural Frequency Change

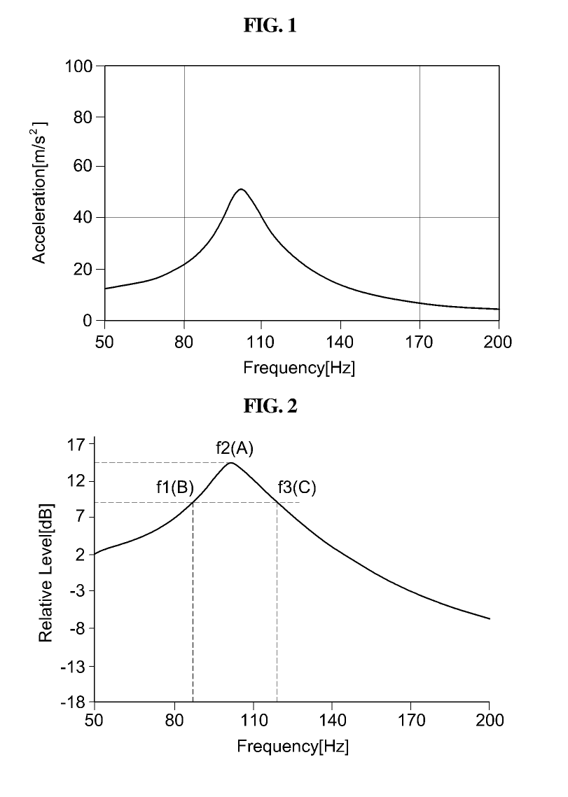

A damper was mounted to a vibration tester, and was then accelerated for a sweep time of 1 min at an acceleration of 1G (9.81 m/s²). Thereafter, as shown in FIG. 1, the natural frequency of the product was measured based on the principle of finding the resonance point on the product by tracking the peak at which the greatest acceleration occurred on the product depending on the frequency. FIG. 1 is a graph illustrating an acceleration peak depending on the frequency for natural frequency measurement according to an exemplary embodiment of the present invention. The test temperature range for temperature dependency was maintained using a chamber that may be coupled with the vibration tester, and the natural frequency change was measured in each test temperature range.

(2) Measurement of Loss Factor

The relative level depending on the frequency was measured in the same manner as in the measurement of natural frequency change. FIG. 2 is a graph illustrating a dB peak depending on the frequency for the measurement of loss factor according to an exemplary embodiment of the present invention. Based on the graph of FIG. 2 and the following loss factor calculation method, the loss factor value was measured.

Loss factor calculation method (3 dB measurement method): (f3−f1)/f2

f2(A): Hz at the highest dB,

f1(B): Hz resulting from subtracting 3 dB from the highest dB

f3(C): Hz resulting from subtracting 3 dB from the highest dB

TABLE 1

| | Composition (parts by weight) | | | | | | | Properties | |
|---|---|---|---|---|---|---|---|---|---|
| | Resin (100 parts | | | | | | | Temperature | |
| | by weight) | | | | | | | dependency | Loss |
| | EPDM | | CI- | | | | | (−20° C. natural | factor |
| | rubber | NR | IIR | | Crosslinking | Vulcanizing | | frequency | (at |
| No. | (wt %) | (wt %) | (wt %) | Filler | agent | accelerator | Plasticizer | change) | 23° C.) |
| Example 1 | 70 | — | 30 | 35 | 2 | 4 | 18 | 67% | 0.298 |
| Example 2 | 80 | — | 20 | 35 | 2 | 4 | 18 | 49% | 0.241 |
| Example 3 | 90 | — | 10 | 35 | 2 | 4 | 18 | 27% | 0.211 |
| Comparative | 60 | — | 40 | 35 | 2 | 4 | 18 | 117% | 0.309 |
| Example 1 | | | | | | | | | |
| Comparative | 95 | — | 5 | 35 | 2 | 4 | 18 | 33% | 0.173 |
| Example 2 | | | | | | | | | |
| Comparative | 100 | — | — | 35 | 2 | 4 | 18 | 27% | 0.177 |
| Example 3 | | | | | | | | | |
| Comparative | — | 60 | 40 | 35 | 2 | 4 | 18 | 173% | 0.329 |
| Example 4 | | | | | | | | | |

EPDM rubber: Ethylene propylene diene monomer rubber, Kumho Petrochemical KEP 7141
NB: Natural rubber
CI-IIR: Chloro-isobutylene-isoprene rubber, ExxonMobil 1066
Paraffinic oil: Kukdong oil & Chemicals KD P 10S
Filler: Carbon black
Crosslinking agent: Sulfur
Vulcanizing accelerator: Mixture of ZnO and Stearic acid
Plasticizer: Paraffin oil
Temperature dependency: Natural frequency change at −20° C.
Loss factor (tanδ): Loss factor (tanδ) at a frequency of 50 to 200 Hz and a temperature of −20° C.

As is apparent from the results of Table 1, Examples 1 to 3 exhibited a temperature dependency at a temperature of −20° C. of 67% or less and a high loss factor at a temperature of 23° C. of 0.241 or greater.

However, Comparative Examples 1 and 4 manifested a good loss factor but a high temperature dependency greater than 100%. Also, in Comparative Examples 2 and 3, the loss factor at a temperature of 23° C. was 0.177 or less, which was substantially reduced.

Particularly, in Comparative Examples 3 and 4 using the resin, both the temperature dependency and the loss factor were deteriorated or increased together, from which it was deemed to be difficult to satisfy required properties based on the two sets of conditions.

Thereby, when the resin including the ethylene-propylene-based rubber and the halogenated isobutylene-isoprene rubber at an optimal mixing ratio was used, the natural frequency change at a temperature of −20° C. was minimized and the loss factor at a temperature of 23° C. was maintained at a predetermined level or greater, thereby improving anti-vibration characteristics as the main performance requirement of the damper.

### Test Example 2

### Measurement of Temperature Dependency and Loss Factor Depending on Changes in Temperature

The dampers of Example 2 and Comparative Examples 3 and 4 were measured for temperature dependency and loss factor in the temperature range of −20 to 100° C. in the same manner as in Test Example 1. The results are shown in Table 2 below.

TABLE 2

| | | Temperature (° C.) | | | | | |
|---|---|---|---|---|---|---|---|
| No. | Test items | −20 | −10 | 0 | 23 | 70 | 100 |
| Example 2 | Natural frequency change | 49 | 48 | 27 | 0 | −25 | −39 |
| | (%) | | | | | | |
| | Loss factor | 0.652 | 0.662 | 0.450 | 0.241 | 0.204 | 0.192 |
| Comparative Example 3 | Natural frequency change | 27 | 23 | 10 | 0 | −28 | −42 |
| | (%) | | | | | | |
| | Loss factor | 0.357 | 0.313 | 0.220 | 0.177 | 0.181 | 0.230 |
| Comparative Example 4 | Natural frequency change | 173 | 113 | 27 | 0 | −24 | −30 |
| | (%) | | | | | | |
| | Loss factor | 0.895 | 0.859 | 0.539 | 0.329 | 0.127 | 0.119 |

As shown in Table 2, in Example 2, the natural frequency change in the temperature range of −20° C. to 0° C. was maintained as low as 49% or less. Also, the loss factor was maintained as high as 0.450 to 0.652 in the above temperature range. Furthermore, the natural frequency change and the loss factor were maintained or improved even in the high temperature range of 23 to 100° C., compared to Comparative Examples 3 and 4.

On the other hand, in Comparative Example 3, the natural frequency change was good in the temperature range of −20 to 100° C., but the loss factor values were decreased to 0.177 and 0.181 at a temperature of 23° C. and 70° C., respectively, which were evaluated as not satisfying the required properties.

In Comparative Example 4, the natural frequency change was drastically increased to 113% or greater at temperatures of −20° C. and −10° C., and the loss factor values were as low as 0.127 and 0.119 at temperatures of 70° C. and 100° C., respectively.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A rubber composition for a dynamic damper, comprising:
a resin comprising an amount of about 70 to 90 wt % of an ethylene-propylene-based rubber and an amount of about 10 to 30 wt % of a halogenated isobutylene-isoprene rubber based on the total weight of the resin;
a filler;
a plasticizer;
a crosslinking agent; and
a vulcanizing accelerator.

2. The rubber composition of claim 1, wherein the ethylene-propylene-based rubber comprises ethylene propylene diene monomer rubber.

3. The rubber composition of claim 1, wherein the halogenated isobutylene-isoprene rubber comprises chloro-isobutylene-isoprene rubber, bromo-isobutylene-isoprene rubber, or a mixture thereof.

4. The rubber composition of claim 1, wherein the filler comprises at least one selected from the group consisting of carbon black, calcium carbonate, talc, clay, silica, mica, titanium dioxide, graphite, wollastonite, and nanosilver.

5. The rubber composition of claim 1, wherein the plasticizer comprises paraffin oil.

6. The rubber composition of claim 1, wherein the crosslinking agent comprises peroxide, sulfur, or a mixture thereof.

7. The rubber composition of claim 1, wherein the vulcanizing accelerator comprises zinc oxide, stearic acid, or a mixture thereof.

8. The rubber composition of claim 1, wherein the rubber composition comprises an amount of about 30 to 40 parts by weight of the filler, an amount of about 15 to 25 parts by weight of the plasticizer, an amount of about 1 to 5 parts by weight of the crosslinking agent, and an amount of about 1 to 5 parts by weight of the vulcanizing accelerator, based on 100 parts by weight of the resin.

9. The rubber composition of claim 1, wherein the rubber composition has a natural frequency change of 70% or less at a temperature of about −20 to about 0° C.

10. The rubber composition of claim 1, wherein the rubber composition has a loss factor (tan δ) of about 0.192 to 0.662 at a vibration frequency of about 50 to 200 Hz and a temperature of about −20 to 100° C.

11. A dynamic damper, comprising a rubber composition of claim 1.

12. A vehicle comprising a dynamic damper of claim 11.
